(19) United States
(12) Patent Application Publication
(10) Pub. No.: US 2010/0294794 A1
(43) Pub. Date: Nov. 25, 2010

(54) SOLIDS INJECTION PROCESS FOR ADDING PREDETERMINED AMOUNTS OF SOLIDS

(75) Inventors: George Yaluris, Park Ridge, IL (US); Natalie C. Petti, Annapolis, MD (US)

Correspondence Address: W.R. GRACE & CO.-CONN., 7500 GRACE DRIVE, COLUMBIA, MD, 21044, US

(73) Assignee: W. R. GRACE & CO. - CONN., Columbia, MD (US)

(21) Appl. No.: 12/469,412

(22) Filed: May 20, 2009

(51) Int. Cl. B67D 7/00

(52) U.S. Cl. 222/1

(57) ABSTRACT

A method is disclosed for controlling or monitoring the injection of one or more solids in a system, process, unit or apparatus by mathematically modeling the independent injection of the solids to maintain a determined or pre-determined ratio, percentage, fraction or relative amounts of total solids injected. The model uses historical process data, current process data and/or data from an external source to adjust set points in the master controller to maintain a predetermined amount of solids to be injected within a given period of time. In accordance with the process of the invention, new set-points are generated in the master controller using variables other than a unit or system response variable as input into the model.

### FIELD OF THE INVENTION

The present invention relates to a method for monitoring or controlling the injection of solids into a given system, process, unit or apparatus. In particularly, the present invention relates to a method for controlling or monitoring the injection of solids in a system, process, unit or apparatus using current and/or historical unit data to mathematically model the injection of a solid to maintain a determined or pre-determined ratio, percentage, fraction or relative amounts of total solids injected.

### BACKGROUND OF THE INVENTION

Solid injection is a well-known method for delivering solid components to a desired process, system, unit or apparatus. Injection systems control the amount of a given solid injected into a system to achieve a relative amount of the solid in the total solids injected. Injection of solids can occur using one or more single solid injection systems, i.e. loader, each one capable of injecting only one solid, or by using multiple solids injection systems, e.g. a multi-loader. Multiple solids injection systems are especially useful for maintaining solids injection rates within a desirable range relative to the amounts of solid components necessary to achieve a desired result.

For example, fluid catalyst cracking (FCC) units are commonly used in petroleum refining to break long chain hydrocarbons present in crude oil. A main catalyst is generally introduced into the FCC unit by a solid injection system which periodically meters out catalyst for injection over a pre-defined period of time. In addition to the main catalyst, it is often beneficial to inject other catalysts and/or additives into the FCC unit to further influence the refining process. For example, some catalysts are formulated to control certain types of emissions, e.g. the amount of sulfur- and nitrogen-containing compounds present in refinery emissions. Other catalysts may be formulated to influence the product mix recovered from the main fractionators and other separation equipment downstream of an FCC process. For example, the catalyst may be formulated to produce more diesel fuel relative to gasoline or to increase the amount of liquid petroleum gas produced.

Catalyst additives, also in the form of fluidizable solids, are typically injected along with the cracking catalyst or separately to modify the cracking catalyst activity or selectivity (e.g., increase conversion and bottoms cracking and improve gasoline or light olefins yields), improve or change product properties (e.g., increase gasoline octane, or reduce olefin or sulfur concentration in gasoline), or to improve unit operation and reduce pollutant emissions (e.g., improve fluidization, control afterburn and reduce CO, NOₓ and SOₓ emissions). To be effective the additive (or additives) needs to be injected within a range of relative amount to the cracking catalyst. In addition, Consent Decrees signed between the EPA and refiners may mandate that an additive (or additives) is added at a specific percent or within a specific range of percentages of the additive versus the cracking catalyst added.

Various solid injection systems and method of controlling the injection of solids into a defined system, unit, process or apparatus are known. See, for examples, U.S. Pat. No. 6,508,930 B1, U.S. Pat. No. 6,878,656 B2, U.S. Pat. No. 5,389,236, and U.S. Pat. No. 6,358,401. However, those skilled in the art will appreciate that “automatic” methods here to afore developed for controlling the introduction of solids are by no means “automatic”. Many so called “automatic” solid injection systems must be continuously monitored and controlled manually even though the solid addition systems are placed on a mechanical timer to add a nominal volume of solid according to a predetermined schedule. However, these systems fail to take into account other solids injected and cannot maintain a predetermined ratio, fraction or relative amount of said solid in the total solids inventory or any other solid injected in the system, process, unit, and/or apparatus. For example, in many FCC processes, metered catalyst addition systems are continuously monitored and controlled manually until errors in the addition of the catalyst accumulate to a point where the system begins to operate beyond a given performance level, e.g., until too much SOₓ, or too little gasoline of a given quality or too much coke is produced. At such a point, the metered system is “overridden” and the catalyst is “manually” introduced or withheld until the operation of the system or unit is returned to the desired performance level as determined by a given performance parameter being controlled by a particular catalyst.

Another widely used method of controlling the injection of solids is a loop feedback method. In FCC unit, for example, the temperature of the riser is controlled in a loop feedback by the amount of catalyst that is charged to the riser. Models operating loop feedback controller determine how much of an input variable (i.e. the amount of a catalyst to be injected in an FCC process) should be changed to affect a specific change to the monitored response variable (i.e. the desired temperature in the riser). Typically, control loop feedback models are empirical and are determined so that a monitored process variable is controlled by a response factor times an input variable function, where the response factor is determined empirically. One example of a loop feedback controller is proportional-integral-derivative (PID) controller. A PID controller attempts to correct an error between a measured process variable and a desired set point by calculating and then outputting a corrective action that can adjust the process accordingly.

Prior known methods for controlling the accuracy of the injection of a solid generally control the injection of a single solid product. Such prior methods e.g. feedback loop methods, typically depend on the measurement of a response variable to adjust solid injections and bring said response variable within a desirable range of value. Notably, prior control methods for controlling the injection of a solid have not here to afore involved the use of model development of process variables other than response variables.

Consequently, there exists a need in various industries, including the refining industry, for improved methods and apparatuses for automating, controlling and monitoring the injection of one or more solids into a desired operational system, process, unit or apparatus.

### SUMMARY OF THE INVENTION

The present invention is directed to an automatic solid injection system or process. In accordance with the present invention, historical and current process data are used to formulate a mathematical model for calculating a determined or predetermined amount of one or more solids to be injected into a desired system, process, unit and/or apparatus to maintain predetermined amounts, ratios, percentages or fractions of the one or more solids to be injected. The model determines the amount of a solid or solids to be injected to achieve a desired change in the value of the response variable, thereby determining new set points for the injection system controller. Advantageously, the process of the invention generates new set-points for the system controller using variables other than a unit or system response variable as input into the model.

In one embodiment of the present invention, a process is provided for injecting at least one solid into a system, process, unit or apparatus while maintaining a predetermined ratio, fraction or relative amount of the solid in the total amount of solids to be injected.

In another embodiment of the present invention, a process is provided for injecting at least one solid into a system, process, unit or apparatus while maintaining a predetermined ratio, fraction or relative amount of the solid in a total solid inventory in the system, process unit or apparatus, e.g. to maintain a predetermined ratio, fraction or relative amount an additive in the total catalyst inventory in an FCC process.

In another embodiment of the present invention, a process is provided for injecting at least one solid into a system, process, unit or apparatus while maintaining a predetermined ratio, fraction or relative amount of the total amount of another solid or solids injected into said system, process, unit or apparatus, e.g. to maintain a predetermined ratio, fraction or relative amount of one or more additives injected in an FCC catalyst inventory relative to the amount of a catalyst injected into total catalyst inventory.

In still another embodiment of the present invention, a process is provided for automating the injection of at least one solid into a system, process, unit or apparatus while maintaining a predetermined ratio, fraction or relative amount of the solid in the total amounts of solids to be injected.

In another embodiment of the invention, a process is provided of mathematically modeling the injection of one or more solids into a system, process, unit or apparatus using variables other than a unit or system response variable as input to the model.

In another embodiment of the invention, a process is provided of mathematically modeling the injection of one or more solids into a system, process, unit or apparatus using historical and/or current data as input into the model.

In yet another embodiment of the invention, a computerized system for hosting a mathematical model for determining and controlling the amount of at least one solid to be injected into a system, process, unit or apparatus to achieve specific ratios, percentages, fractions, or relative amounts of total amount of solids injected is provided.

In another embodiment of the present invention, a process is provided for injecting at least one catalyst/additive solid into an FCC system, process, unit or apparatus while maintaining a predetermined ratio, fraction or relative amount of said at least one catalyst/additive in the total catalyst inventory.

In another embodiment of the present invention, a process is provided for automating the injection at least one catalyst/additive into an FCC system, process, unit or apparatus while maintaining a predetermined ratio, fraction or relative amount of said at least one catalyst/additive in the total catalyst inventory.

In another embodiment of the invention, a process is provided of mathematically modeling the injection of one or more catalyst/additive into an FCC system, process, unit or apparatus using variables other than a unit or system response variable as input to the model.

In another embodiment of the invention, a process is provided of mathematically modeling the injection of one or more catalyst/additive into an FCC system, process, unit or apparatus using historical and/or current data as input to the model.

In yet another embodiment of the invention, a computerized system for hosting a mathematical model for determining and controlling the amount of a catalyst/additive to be injected into an FCC system, process, unit or apparatus to achieve specific ratios, percentages, fractions, or relative amounts of total catalyst inventory is provided.

These and other aspects of the present convention are described in further details below.

### BRIEF DESCRIPTION OF THE DRAWINGS

FIG. 1 is a schematic representation of a master controller independently connected to each Injection System A, B, C and D, wherein the controller receives information from each Injection System A, B, C and D and thereafter independently adjusts each subsequent injection of Injection System A, B, C and D to maintain a predetermined relative amount of each solid injected within a predefined time period.

FIG. 2 is a schematic representation of a master controller connected to a source for mathematically modeling and independently connected to each Injection System A, B and C for receiving information from each Injection System A, B and C, and thereafter independently adjusting each subsequent injection of Injection System A, B and C to maintain a predetermined relative amount of each solid injected within a predefined time period, wherein a source for mathematically modeling is connected to a means for receiving historical data, data from external labs and other model inputs, e.g. current data.

FIG. 3 is a schematic representation of a master controller independently connected to a cracking catalyst injection system for injecting a cracking catalyst into an FCC Unit, and three additional Injection Systems B, C and D for independently injecting additional solids into the FCC Unit, wherein the master controller receives information regarding the amount of each solid to be injected by each injection system and independently adjusts subsequent injections of each injection system to maintain a predetermined relative amount of each solid to be injected into the FCC Unit relative to the amount of the cracking catalyst within a predefined time period.

### DETAILED DESCRIPTION OF THE INVENTION

The invention comprises a process for automatically injecting at least one solid in a system, process, unit, apparatus, such as an FCC unit, while maintaining a predetermined ratio, percent, fraction or relative amount of the solid injected in the total amount of solids to be injected to achieve a desired response to a given variable. In accordance with the invention, the process comprises connecting at least one solid injection system, preferably one or more solids injection systems, most preferably, any combination of one or more multi-injection solids system, with a master controller system having set points for one or more solids to be injected, wherein the master controller is capable of receiving input values regarding the amount of each solid to be injected, based on the total amount of solids to be injected, and capable of calculating set points for the amount of each solid to be injected based on input values to maintain a predetermined ratio, percent, fraction or relative amount of each solid to be injected to achieve a desired response to a given variable; inputting process data selected from the group consisting of historical process data, current process data, process data from an external source, or a mixture thereof, into the master controller; calculating, based on the process data, the amount of each solid to be injected to maintain said pre-determined relative amount of the solid to be injected; and optionally, adjusting a set point in the master controller to maintain said pre-determined relative amount of each solid and allow each solid injection system to adjust, based on an adjusted set point, the amount of each solid to be injected within a given time period.

For purposes of the present invention, the terms “master controller” or master “control system” are used herein interchangeably to indicate any device or system having set points for a pre-determined relative amount of a solid to be injected based on a total amount of solids to be injected into a given system, process, unit or apparatus, said device or system being capable of independently connecting one or more solid injection systems, receiving input data for determining the amount of a solid to be injected and adjusting the amount of solid injected to maintain said pre-determined relative amount of the solids, i.e. ratio, percents, fractions, or relative amount, in the total solids to be injected into the given system, process, unit or apparatus.

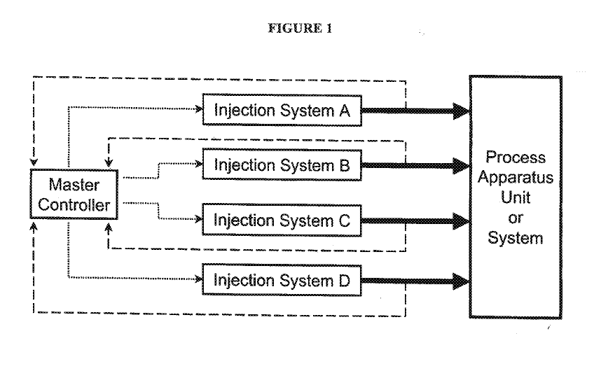

Preferably, the amount of solid to be injected is an amount sufficient to maintain a predetermined relative amount of a given solid to be injected within a predefined time period. In one embodiment of the invention as shown in FIG. 1, each of solid injection systems A, B, C and D are independently connected with a master controller in a manner such that the master controller receives information from each Injection System A, B, C and D and thereafter independently adjusts set points within the controller for each subsequent injection of solids from Injection Systems A, B, C and D, based on a given set point, to maintain a predetermined relative amount of each solid injected in a given process, apparatus, unit or system, within a predefined time period.

In accordance with the present invention, the master controller may be a stand alone system for individually controlling each injection system. Alternatively, the master controller may be part of a control system which individually controls any or all of the injection systems. It is also within the scope of the present invention that the control system may be part of a centralized control system of any of the controllers individually controlling each injection system. The master controller may also be part of a centralized control system such as a Distributed Control System (DCS). It is also contemplated in the present invention that the master controller may reside on a laptop, tablet PC, desktop, mainframe, or other suitable computer device. It is also with in the scope of the present invention that the control system may reside on a remote computer or server communicating with the controller of each injection system via a local network or via the Internet. For example the controller may be part of e-Catalysts® receiving information via a user data upload interface, or with Industrial Evolution software. For purposes of the present invention the term “e-Catalysts®” is used herein to designate an Internet based source of customized technical service for catalyst users operated by Grace Davison, a division of W.R. Grace & Co.—Conn., which is capable of receiving data remotely via the Internet and providing the customized technical services, e.g. the amount of a catalyst to be injected, also via the Internet. For purposes of the present invention the term “Industrial Evolution” is used herein to designate an Internet source that capture, stores, transforms, exchange and present real-time process data from an industrial operation via the Internet.

Communication with local solids injection devices may be manually, i.e., the operator manually inputs data to e-Catalysts® and results to the injection device controller, or automated, i.e. data input is performed by direct connection, wired or wireless, with the local network or the Internet.

Set points in the master controller are determined based on the intended use of the solid, e.g. catalyst or additive. For purposes of the present invention the term “set point” is used herein to designate a targeted value of a response variable. It is within the scope of the present invention that there may be one or more set points in a master controller.

For purposes of the present invention the term “response variable” is used herein to indicate a system, process unit and/or apparatus variable which takes a value which is variable within a desirable range of values in response to a given set of conditions. Suitable response variables, include, but are not limited to, process variables, product amount(s) or property(ies), concentration(s), amount(s) and composition(s) of solid, liquid or gaseous waste streams, a process variable to be controlled, and the like. Where the process is a catalytic industrial process, unit or apparatus, the response variables may include, but are not limited to, the activity of a catalyst inventory in a given process, unit or apparatus; the yield of a product produced in a given process; unit or apparatus, a required property or quality criterion of a product produced from the process, unit or apparatus, the concentration of a pollutant to be controlled in a waste stream process, unit or apparatus, a process variable to be controlled, and the like. In particularly, in an FCC process or unit, the response variable may include, but is not limited to, the concentration of sulfur, olefins, benzene or aromatics in gasoline not be exceeded, the maximum bottoms, hydrogen, dry gas yield, a desired gasoline or light cycle oil yield, a pollutant concentration in a waste stream set by regulation or a Consent Decree between the EPA and the refinery, such as a CO, SOₓ, NOₓ, NH₃, H₂S or carbonyl sulfide (COS) emissions limit in the flue gas from the FCC unit regenerator, the amount of propylene, butylene or light petroleum gas to be made, the fluidization property for the catalyst inventory, the maximum afterburn or temperature in the regenerator that the unit metallurgy will allow, the coke on regenerated catalyst, the metals such as nickel, vanadium, iron or sodium on the equilibrium catalyst, and the like.

In a preferred embodiment of the invention, the process comprises a mathematical model suitable for calculating, based on process data input, the amount, including but not limited to, ratios, percentages, fractions or relative amounts, of one or more solids required to be injected to achieve a desired effect in response to a given variable.

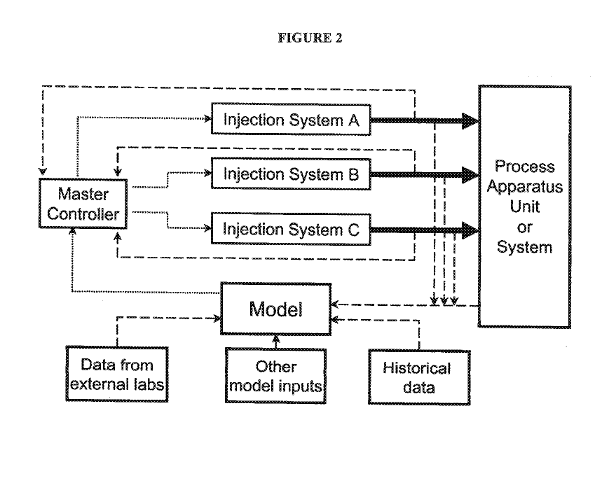

As shown in FIG. 2, the model receives input data which data may be historical data or current data, or data from other external sources and utilizes the input data to determine the amount of one or more solids to be injected in to a given process, apparatus, unit or system. The master controller receives the information from the model and adjusts injection systems to deliver the amount of solid determined by the model and maintain the model-determined relative amount of each solid injected within a pre-defined time period.

For purposes of this invention, the term mathematical model is used herein to designate any mathematical formulation, including, but not limited to, linear and non-linear regression, neural network, Monte-Carlo, heuristic, stochastic, LP models and the like, which uses historical and/or current data to estimate the suitable amount of one or more solids to be injected. The model can be as simple as a single equation allowing calculation of the needed product amount or more complex requiring a computerized source (e.g. Excel®, Visual Basic®, AspenTech®, Profimatic® based software and the like) to produce an output based on the data input. The model may be based on a mechanistic understanding of the process, or it may be empirical, or a suitable combination of the two.

In addition to a mathematical formulation, the model may also consists of screens for data entry (manual or automatic), e.g., by typing data on a computer, reading data from a storage medium or receiving data from a measurement device or other local or centralized measurement and process control system such as a Distributed Control System (DCS). The model may also be combined or integrated with other models used to simulate and control unit performance and product amounts and properties (e.g., in the case of a refinery KBC's Profimatics® refinery model, LP refinery model, AspenTech® Petroleum refinery model and the like.)

A computerized application incorporating the model may also be used to notify the user of such factors as, for example, missing input data, potentially poor quality or erroneous input data, data outside the regime where the model is valid, accurate or applicable, and the like, or to compile the total amount of additions and determine inventory conditions for solid being injected, or incorporated into a supply chain management process to ensure consistent product supply.

Input data used in the model may be historical data or current data. Historical data is defined herein to indicate any data collected at any time prior to the current time. Depending on the time intervals used to collect data for any particular process and any particular variable, for example, seconds, minutes, fraction of an hour, hours, days(s), week(s), the data may be collected at or before the last instance prior to when the current date was collected, for example, the prior second, minute(s), fraction of an hour, hour(s), day(s), week(s) time interval and the like. Typically, historical data suitable for use in the model will include any process data collected during a prior operation of the system, process, unit or apparatus where the solids are to be injected spanning days, weeks, months or even years of operation. Such process data include, but are not limited to, temperatures, pressures, flow rates, energy inputs and outputs, other process conditions, solids inventory amounts, concentrations of the various solids incorporated in the inventory, chemical and physical properties of the solids in the inventory (e.g. chemical analyses, average particle size and particle size distribution, density, apparent bulk density, surface area, hardness and crystallographic data, such as cell size for zeolite type materials), unit process rates (e.g. feed or reagent rates, solids flow rates, and the like), solid injection rates/amounts, amount of solids losses from the process, amount of solids withdrawn from the process, feedstock compositions, properties and amount, including the same for each feedstock stream combined to make the final feedstock fed to the process, product rates/amounts made, product properties, amounts, rates and properties of any process effluent (solid, liquid or gaseous), amounts and properties of any material accumulating within the process, energy input or output from the process (including heat, electricity, kinetic or other form of mechanical energy such as stirring), and the like. Historical data can be data as collected or data averaged over a suitable period of time as determined by one skilled in the art, e.g. every hour, day, week, and the like.

Current data is defined herein as any data collected simultaneously to the instance or substantially at the same time as when the response variable which is be controlled or monitored is controlled by adjusting the amount of solids injected into the process. Current data typically include, but are not limited to, the same type of data as suitable for historical data collected contemporaneously with the use of the model. That is, data collected simultaneously with or at the last time interval, e.g. minute, hour, day, week or other suitable time interval prior to, using the model to make the necessary calculation(s) for input into the master controller. Current data may also include data collected on-line and/or communicated to the model contemporaneously via a local network and/or the Internet.

Input data used by the model may also be communicated from a remote database. For example, input data may be uploaded by the user on or from e-Catalysts® as the case may be via a user data upload interface, or with the Industrial Evolution software. Additional data may be uploaded for the model to use from a laboratory management system, i.e. Global Laboratory Information Management System (GLIMS), and any other database containing input data useful to performing the model calculations. The model may be located on a local desktop, laptop or other suitable computer device or it or may reside on a remote computer or by employing a suitable Internet service (e.g., e-Catalysts.com and Industrial Evolution software).

The present invention may be used in any process which requires the injection of one or more solids while maintaining predetermined ratios, percentages, fractions or relative amounts of the total solids injected. For example, the present invention is useful in any fluidized process, such as FCC, fluidized bed combustors, pyrolysis such as biomass pyrolysis, gasification, such as coal, coke or biomass gasification, absorption process utilizing solids such as fluidizable solids used to control SOₓ, NOₓ, mercury and other emissions from coal burning power plants, and the like.

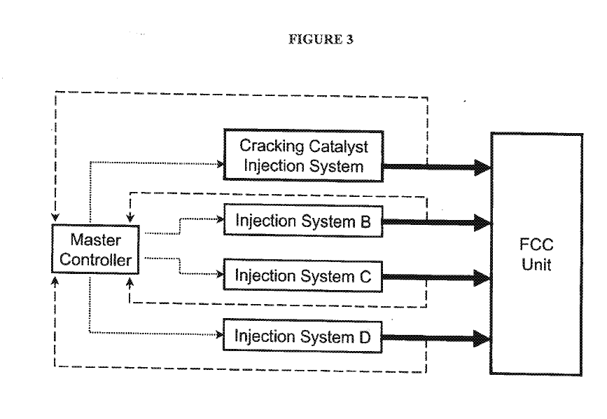

Preferably, the present invention is useful in a FCC unit or process. FIG. 3 outlines an embodiment of the invention wherein the process is an FCC process. The process utilizes an FCC unit independently connected to four solid injection systems wherein one of the solid injection systems comprising an injection system injects a cracking catalyst, and the remaining systems for injecting a solid, e.g. a catalyst and/or catalyst additive. Each of the injection systems are connected to the master controller which receives information regarding the amount of solids to be injected by each system and adjust any subsequent injections to maintain a predetermined relative amount of each solid with respect to the amount of the cracking catalyst added within a pre-defined time period.

Typically, the catalyst and/or catalyst additive to be added is one used to affect a change in a process variable, such as increase activity, improve selectivity, improve unit operation, decrease sulfur in liquid fuels, reduce air pollutants exiting the regenerator (e.g., CO, SOₓ, NOₓ, NH₃, HCN, H₂S, COS), and the like. In addition, it may be advantageous for an FCC unit operator to manually or automatically vary the relative amounts of the cracking catalyst and/or additive added to improve unit performance and/or compensate for changes in feed quality or composition, for example in order to accommodate a crude change or upstream or downstream unit upsets (e.g. hydrotreaters, crude unit, distillation columns, alkylation units upsets, and the like). In this preferred embodiment all solids are fluidizable powders. Suitable catalysts include any cracking catalyst for use in an FCC unit. Suitable catalyst additives include, but are not limited to, activity increasing additives such as ACTIVA™ and the like; bottoms cracking additives; metals traps used to improve activity and zeolite stability; gasoline increasing additives; butylenes increasing additives; butylenes increasing additives such as BUTIMAX® and the like; propylene increasing additives such as OLEFINSPLUS™, OLEFINSEXTRA™, OLEFINSMAX®, OLEFINSULTRA® and the like; gasoline sulfur reducing additives such as D-PRISM®, GSR®-5, SURCA®, GSR®-7 and the like; CO promoters such as CP®-5, CP-3® and the like; SOₓ reducing additives such as DESOX®, Super DESOX® and the like; NOₓ reducing additives and reduced nitrogen species reducing additives such as XNOx®, DENOX®, DENOX®-PB, DENOX®-2GZ and the like. Typically, each cracking catalyst and/or catalytic additive will be injected at a specific relative amount with respect to the total amount of cracking catalyst or catalysts and additives injected. The amounts of cracking catalyst to be added are uploaded into a master controller, which continuously calculates the amounts of each catalyst, or additive required to be added in order to maintain the catalyst and additive concentrations at predetermined ratios, percentages, fractions or relative amounts based on the total solids to be injected. The amounts of additive and cracking catalyst added are continuously monitored and are subsequently adjusted, respectively, to compensate for any deviations (FIG. 1)

The controller may be a standalone control system, may reside on a laptop, desktop or other suitable computer device, may be part of the system of any of the controllers individually controlling each injection system, may be part of a centralized control system, such as a Distributed Control System (DCS), or may reside on a remote computer or server communicating with the controller of each injection system via a local network or via the Internet. For example, the controller may be part of e-Catalysts® receiving information via a user data upload interface, or used in combination with the Industrial Evolution software which captures, stores, transforms, exchanges and presents real-time process data.

In one embodiment of the invention, at least two additives are injected into the FCC unit in amounts which are independent of the amount of cracking catalyst additions, but are at predetermined relative amounts to each other. The additive injections are monitored by a master controller, which maintains the cracking catalyst injection rate at the desired level and adjusts the additives injections as described above to achieve the desired addition level for the additives while maintaining the pre-determined relative amounts of each additive added. In a preferred embodiment of the invention at least one multi-loader may be used in the FCC unit or process to inject at least one catalyst and/or catalyst additive at predetermined relative amounts, or the same multi-loader/multi-loaders may be used, to maintain a predetermined level of catalyst additions. Catalytic additives may be added in amounts independent of the amount of catalyst additions. The additives may be injected at predetermined relative to each other amounts. Each multi-loader injecting more than one product is controlled to conduct sequential additions of each product, thus injecting the predetermined amount within a specified period of time. In this case, a master controller or master control system having set points for the relative amounts of solids to be injected (or ratio, or percent or fraction), receives input from each multi-injection system regarding the amount of the various catalysts or additives being injected, calculates the amounts of each solid needed to be injected and instructs the controller of each multi-injection system to inject a sufficient amount of each product to maintain determined ratios, percents, fractions, or relative amounts for a given time period.

The invention can be used in an FCC process, unit, apparatus or system to comply with EPA, state or local authority regulation, permit, or Consent Decree specified injection ratios, fractions percents or relative amounts of products required to be injected into the unit, such as the relative amounts of environmental additives to fresh cracking catalyst. This process may be used to estimate and add the amount of one or more environmental additives needed to achieve compliance with an air emissions or other permit, regulation or Consent Decree requirement. In addition, the present invention can be used to add catalysts and additives in either pre-determined or determined by a model relative amounts in order to improve conversion, product yields and properties (e.g., increase gasoline, octane number, diesel, cetane number, propylene, and butylenes, and fluidization, reduce afterburn and the like), or reduce pollution (e.g., reduce CO, NOₓ, SOₓ, NH₃, HCN, H₂S, COS emissions from the regenerator). Furthermore, the present invention can be used to manually or automatically adjust the catalyst composition on-site by varying the relative amounts of different cracking catalysts injected to improve the ability of the unit to handle feed changes due to different crude sources and/or upstream or downstream unit upsets.

To further illustrate the present invention and the advantages thereof, the following specific example is given. The example is given as specific illustration of the claimed invention. It should be understood, however, that the invention is not limited to the specific details set forth in the example.

All parts and percentages in the examples as well as the remainder of the specification that refers to solid compositions or concentrations are by weight unless otherwise specified. However, all parts and percentages in the examples as well as the remainder of the specification referring to gas compositions are molar or by volume unless otherwise specified.

Further, any range of numbers recited in the specification or claims, such as that representing a particular set of properties, units of measure, conditions, physical states or percentages, is intended to literally incorporate expressly herein by reference or otherwise, any number falling within such range, including any subset of numbers within any range so recited.

### EXAMPLE

An FCC unit is required to maintain SOₓ emissions in the flue gas at a level below the applicable permit. Historical unit operating data, product yields and properties, injection rates for catalyst and SOₓ additive, and empirical information on SOₓ additive activity are used to construct a model that is specific to that particular FCC unit and the particular SOₓ additive employed (SuperDESOX®). The model is located on the e-catalyst.com website and is available to the user located at the FCC unit. The user inputted the data remotely on a daily basis and the model predicted the amount of SOₓ additive required to maintain the target SOₓ emissions. The model output (a target injection rate of SOₓ additive) is used as the set point for the SOₓ additive injection system controller. The application sent warning messages to technical personnel at both the additive supply site and the refinery when input data were missing for a time period or the quality of the data entered was suspect.

What is claimed is:

1. A method for monitoring or controlling the injection of solids into a given system, process, unit or apparatus, the method comprising:
providing at least one solid injection system for injection of at least one solid into a given system, process, unit or apparatus;
connecting said at least one solid injection system to a master controller having a set-point for an amount, ratio, percentage or fraction of each solid to be injected based on a total amount of solids to be injected into a given system, process, unit or apparatus, said master controller being capable of receiving input data, calculating the amount of the solid to be injected and independently adjusting the amount for each solid to be injected to maintain the pre-determined relative amount of the solid in the given system, process, unit or apparatus;
inputting process data into the master controller;
calculating, based on the process data, the amount of each solid to be injected to maintain said pre-determined relative amount of the solid to be injected;
and optionally, adjusting the set point in the master controller to maintain said pre-determined relative amount of each solid of each solid to be injected within a given time period.

2. The method of claim 1 wherein the solid injection system comprises at least two solid injection systems.

3. The method of claim 1 wherein the solid injection system comprises more than two solid injection.

4. The method of claim 3 wherein the master controller is a stand alone system for controlling each injection system.

5. The method of claim 2 or 3 wherein the master controller is part of a centralized control system.

6. The method of claim 2 or 3 wherein the master controller is located on a computer device.

7. The method of claim 1 wherein a mathematical model is used to calculate the amount of solid to be injected to maintain said pre-determined relative amount of the solid to be injected within a given time period.

8. The method of claim 7 wherein the mathematical model is a mathematical formulation selected from the group consisting of non-linear regressions, linear regressions, neural network formulations, Monte-Carlo formulations, heuristic formulations, stochastic formulations, LP formulations, and combinations thereof.

9. The method of claim 7 wherein the mathematical model further comprises means for data input.

10. The method of claim 1 wherein the mathematical model is incorporated into a computerized application.

11. The method of claim 9 wherein the data for input into mathematical model is selected from the group consisting of historical data, current data, data from other external sources, and mixtures thereof.

12. The method of claim 11 wherein the mathematical model utilizes the input data to determine the amount of one or more solids to be injected in to the given process, apparatus, unit or system.
